(19) United States
(12) Patent Application Publication
(10) Pub. No.: US 2006/0170682 A1
(43) Pub. Date: Aug. 3, 2006

(54) Caching For Volume Visualization

(75) Inventor: Filips Van Liere, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/545,650

(22) PCT Filed: Feb. 9, 2004
(86) PCT No.: PCT/IB04/50093

§ 371 Date: Aug. 16, 2005

(30) Foreign Application Priority Data
Feb. 21, 2003 (EP) 03100413.8

(51) Int. Cl. G06T 15/20

(52) U.S. Cl. 345/427; 345/419; 382/128

(57) ABSTRACT

A system for visualizing a 3D volume, represented by a 3D data set stored in a memory (890) as contiguous 2D slices with successive depths. A memory cache 895 provides faster access to part of the data set. A processor 860 creates a 2D representation of the volume by casting an imaginary bundle of n₁×n₂parallel rays through the 3D volume onto a corresponding rectangle of n₁×n₂ pixels. Each time sequentially n₃ samples are determined for each ray, giving a sequence of bundle blocks of each n₁×n₂×n₃ samples. An interpolation function is used to determine a 3D set of voxels contributing to the bundle block. The size of the bundle block is chosen such that the determined set of voxels fits into the cache. The set of voxels is then sampled from the cache.

### FIELD OF THE INVENTION

The invention relates to a system for visualizing a three-dimensional (hereinafter “3D”) volume, in particular for medical applications. The invention also relates to software for use in such systems. The invention further relates to a method of visualizing a three-dimensional 3D volume.

### BACKGROUND OF THE INVENTION

With the increasing power of digital processing hardware (in the form of dedicated pre-programmed hardware or a programmable processor) it has become possible to exploit rendering algorithms in actual systems for generating high-quality images from volumetric data sets. For medical applications, the volumetric data sets are typically acquired using 3D scanners, such as CT (Computed Tomography) scanners or MR (Magnetic Resonance) scanners. A volumetric data set consists of a three dimensional set of scalar values. The locations at which these values are given are called voxels, which is an abbreviation for volume element. The value of a voxel is referred to as the voxel value. FIG. 1 shows a cube 100 surrounded by eight voxels 110. The cube will be referred to as voxel cube or cell.

In medical scanners, typically the data is organized slice by slice, where each slice is two-dimensional. The data in a slice can be represented as gray values. A stack of slices form the 3D data set. A known, relatively simple technique to visualize the contents of a 3D data set is called multi-planar reformatting. This technique can be used to generate arbitrary cross sections through the volumetric data by ‘re-sampling’ voxels in the cross section from the neighboring voxels in the 3D data set. In most cases, flat 2D cross sections are used. In principle, also other curved cross sections can be generated. This technique enables an operator to view an image independent of the direction in which the data was acquired.

FIG. 2 illustrates a more sophisticated volume visualization algorithm that takes as input the entire discrete data field and projects this data field onto a two-dimensional screen 210. Each projection is from a predetermined view point 220 that may be selectable by a user or may be dynamically changed (e.g. giving a virtual tour through the volume). This is achieved by casting a ray 230 from the view point through each pixel (i j) of the imaginary projection screen and through the data field. At discrete k locations 240, 242, 244, 246 along the ray, indicated in light gray, the data is re-sampled from neighboring voxels. Various rendering algorithms are known for calculating a pixel value for pixel (i, j) in dependence on voxels that are near the ray locations in the volume. Examples of such rendering algorithms are volume rendering and iso-surface rendering. By observing a volume from a location sufficiently outside the volume, the ray casting can be represented by parallel rays projecting the image on a 2D screen as is shown in FIGS. 3 and 4, where the illustration in 2D for simplicity. The accumulation of projection information is commonly performed through a function applied to samples taken along the projection rays. Common volume visualization functions are average value, maximum value (the so-called Maximum Intensity Projection or MIP), minimum value and opacity blend (also referred to as alpha blending). Applying an interpolation filter function to the volume at the required sample position forms the samples required by the projection function. FIG. 5 gives a 2D illustration of taking samples (shown as dots 510) taken along a projection ray. The rectangles represent voxels. For a sample to be derived, voxel values in the neighborhood of the sample position must be retrieved from the volume. The number of voxel values required depends on the extent of the interpolation function. Typically, a tri-linear interpolation function is used where the eight nearest voxels contribute to a sample, weighted based on the distance of the sample to the voxel. The voxels that are accessed during linear interpolation of samples of one ray are shown using shading (the illustration is in 2D for simplicity).

Multi-slice CT volume data often consists of 1000 slices of 512² 16-bit voxels. This amounts to about 500 Mbytes of data Conventionally, samples are processed per ray, where the rays are scanned per row and per column. As described above, each sample may require processing of many voxels per sample. In total, a high demand is put on the processing power and storage bandwidth of the processing system.

Most current processors access data in the memory through an intermediate cache memory that provides accelerated access to a chunk of memory, referred to as a cache line. A cache line is often 32 or 64 bytes of data. (In the case of 16-bit voxels, a cache line holds 16 or 32 voxels). When a single voxel is accessed, the entire cache line is retrieved from memory and stored in the cache regardless of whether or not the remaining voxels in the cache line are actually accessed. Accessing voxels in the order in which they are stored in memory results in only a single memory access every 16 or 32 voxels as successive voxels are retrieved from the cache line. Caches have the property that a variety of memory locations map to the same cache line. This is typically the case for corresponding voxels in successive slices of medical images.

In medical imaging it is common to store volume data in a so-called stack of 2D slices, where each slice consists of multiple rows and columns of voxels. FIG. 6A illustrates this organization of volumetric data consisting of a stack of slices (shown are eight slices 610). For one slice the organization into rows and columns of voxels is shown. In the example, eight rows are shown, each including eight columns. Each slice is allocated in a contiguous block of memory, as is illustrated in FIG. 6B. The allocation of volume data in such a fashion allows various image-processing and volume visualization algorithms to access voxels in the three orthogonal directions by means of strides. Row access with a stride of 1, column access with a stride of row length and slice access with a stride row times column length. When accessing volumetric data organized in this fashion, there is a significant difference in memory access times. Accesses to successive voxels in the row direction require a single memory access every 16 or 32 voxels as discussed earlier. When accessing successive voxels in the column and slice directions a memory access is required for each accessed voxel. This can be avoided by accessing multiple voxels simultaneously as is shown in FIG. 7. Shaded voxels represent voxels in a single cache line. Row accesses always make optimal use of the cache. Simultaneous column and stack accesses also make optimal use of the cache.

The approach to multiple simultaneous accesses is only directly applicable to access directions that are aligned with the source volume. For arbitrary projection orientations this approach breaks down. Furthermore, loop control structures for simultaneous processing of multiple rays become complex and dependent on the projection direction.

### SUMMARY OF THE INVENTION

It is an object of the invention to provide an improved algorithm for performing the volume visualization, in particular to better utilize the capabilities of current processing systems.

To meet the object of the invention, a system for visualizing a three-dimensional volume, in particular for medical applications, includes:

an input for receiving a data set representing voxel values of the 3D volume, organized in two-dimensional slices with a sequentially successive depths;

a memory for storing the data set; each slice being stored in a contiguous block of the memory;

a memory cache for temporarily storing part of the data set stored in the memory to provide faster access to data in the cache;

a processor for, under control of a computer program, processing the data set to obtain a 2D representation of the volume by projecting the volume onto an imaginary 2D projection screen of pixels by: casting a bundle of n₁×n₂ parallel rays through the 3D volume on a corresponding rectangle of n₁×n₂ pixels and each time sequentially determining n₃ sequential samples for each ray, giving a sequence of bundle blocks of each n₁×n₂×n₃ samples, where n₁>1, n₂>1, and n₃>1; and for each bundle block: using a predetermined interpolation function to determine a 3D set of voxels contributing to the bundle block, n₁, n₂, and n₃ being chosen such that the determined set of voxels fits into the cache; loading the determined set of voxels from the memory into the cache; and performing the sampling from cache; and

an output for providing pixel values of the 2D representation for rendering. In modern computer systems, the memory latency is large (˜50 ns) with respect to the processor cycle time (<1 ns). Cache latency is usually only a few processor cycles (˜5 ns). The discrepancy between process cycle time and memory access latency is expected to grow as processor cycle times continue to decrease at a rate significantly higher than the decrease in memory access latency. Workstations used for medical image display have about 1 Gbyte of memory, processors with cycle times less than 1 ns and cache memories of about 2 Mbyte. Common volume visualization techniques require in the order of 100 cycles per sample. For 50 ns memory and 1 ns cycle time the processor will be memory bandwidth limited when accessing memory more than twice per sample. For tri-linear interpolation, eight voxels must be accessed for each sample requiring eight memory accesses unless voxels are already available in the cache. Multi-slice CT volume data often consists of 1000 slices of 512² 16-bit voxels. This amounts to about 500 Mbytes of data and clearly does not fit entirely in cache memory. In the conventional processing per ray, voxels that are not in the cache are frequently accessed. Typically, a loaded voxel will be overwritten by a voxel required for one of the later samples along the ray. Since a voxel is usually required for several neighboring rays, the same voxel may be loaded into the cache repeatedly. In the system according to the invention, ray processing is organized in 3D blocks of samples such that all voxels contributing to the samples in the block are loaded into the cache. The size of the blocks and the addressing of voxels in memory are chosen such that this is possible. This enables avoiding repeatedly loading of the same voxels into cache thereby significantly increasing volume visualization performance.

According to the measure of the dependent claim 2, the voxel set fits into a level 1 cache of the processor that operates at very high speed.

According to the measure of the dependent claim 3, the same principle is applied at least two levels. The entire voxel set is divided into bundle blocks that fit into a level 2 cache. The bundle blocks are further sub-divided into sub-bundle blocks that fit into a level 1 cache of the processor. This results in faster access to the bundle block as a whole, compared to access to the main memory, and even faster access to voxels of the sub-bundle during the actual sampling. So, first a bundle block is determined and loaded into the second level cache. Sequentially sub-bundle blocks are determined, loaded in the first level cache and sampling is performed for samples within the sub-bundle block. Processing of the sub-bundle-block can be very fast. Voxels of a bundle-block may be required for several sub-bundle blocks (e.g. due to the interpolation extent, voxels near an edge of a sub-bundle block may be used for sampling of more than one sub-bundle block). By already being in the second level cache, those voxels can be loaded into the first level cache very fast.

According to the measure of the dependent claim 4, the bundle block is a cube, providing a same volume visualization speed from any viewing direction (i.e. the visualization performance is independent of the projection direction).

According to the measure of the dependent claim 5, 2D slices of the 3D data set are stored in the memory with an offset of a multiple of a cache line size. Even though the voxels required for the processing of a bundle block might fit in the cache, different parts of the memory with required voxels may nevertheless be mapped to the same cache line. By introducing the offset, it is ensured that voxels of successive slices are not mapped to the same cache line enabling the simultaneous loading into the cache of the entire collection of voxels required to render the bundle block.

According to the measure of the dependent claim 6, a slice look-up table is used. This is an effective way of controlling storage of the slices in the memory.

To meet an object of the invention, a method of visualizing a 3D volume, in particular for medical applications, wherein the 3D volume is represented by a data set of voxel values organized in 2D slices with successive depths; each slice being stored in a contiguous block of a memory (890) and being accessible through a memory cache (895) for temporarily storing part of the data set stored in the memory to provide faster access to data in the cache; includes processing the data set to obtain a 2D representation of the volume by projecting the volume onto an imaginary 2D projection screen by:

casting a bundle of n₁×n₂ parallel rays through the volume on a corresponding rectangle of n₁×n₂ pixels and each time sequentially determining n₃ sequential samples for each ray, giving a sequence of bundle blocks of each n₁×n₂×n₃ samples, where n₁>1, n₂>1, and n₃>1; and

for each bundle block: using a predetermined interpolation function to determine a 3D set of voxels contributing to the bundle block, n₁, n₂, and n₃ being chosen such that the determined set of voxels fits into the cache; loading the determined set of voxels from the memory into the cache; and performing the sampling from cache.

These and other aspects of the invention are apparent from and will be elucidated with reference to the embodiments described hereinafter.

### BRIEF DESCRIPTION OF THE DRAWINGS

In the drawings:

FIG. 1 shows a voxel cube surrounded by voxels;

FIG. 2 illustrates ray casting and sampling;

FIG. 3 shows projection of a volume onto a virtual 2D screen from a sufficiently far removed observation point;

FIG. 4 illustrates parallel projection rays;

FIG. 5 shows the voxels involved in the sampling;

FIG. 6 shows the organization of a 3D set in a memory;

FIG. 7 shows accessing sequential stored voxels from cache;

FIG. 8 shows a block diagram of a system according to the invention;

FIG. 9 illustrates using caches;

FIG. 10 shows memory access through cache lines;

FIG. 11 shows a bundle of rays according to the invention;

FIG. 12 shows the shell around the bundle block;

FIG. 13 shows clipping of bundle blocks;

FIG. 14 illustrates storing slices with an offset; and

FIG. 15 illustrates using a slice look-up table.

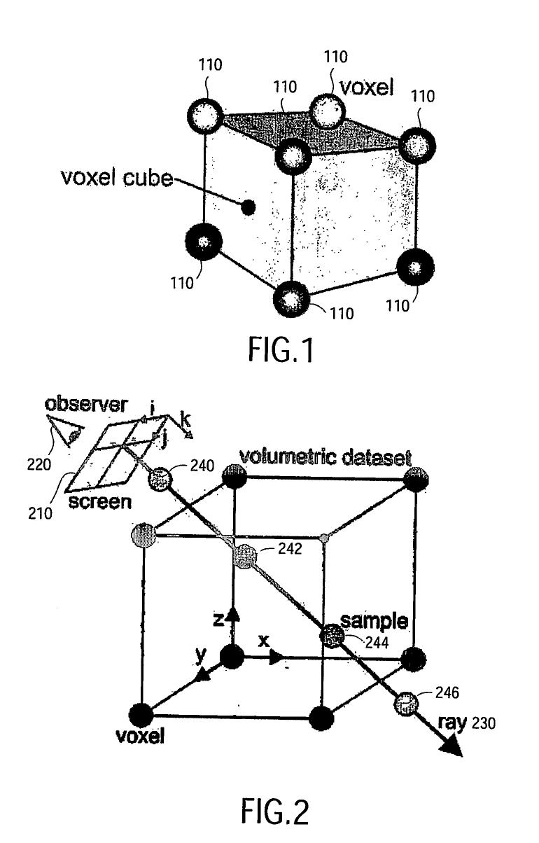

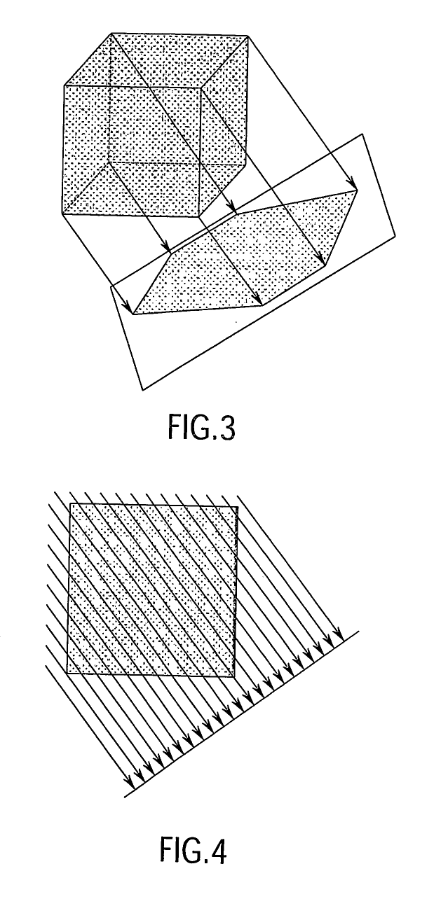

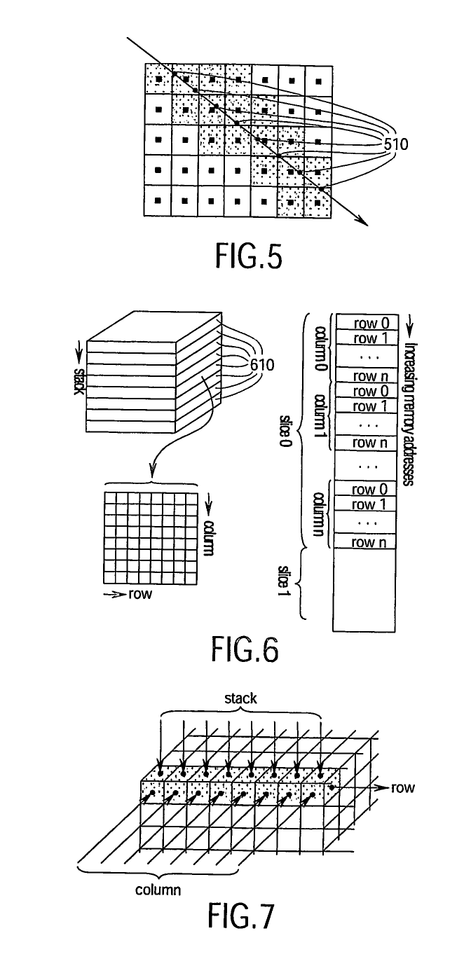

### DETAILED DESCRIPTION OF THE PREFERRED EMBODIMENT

The system for visualizing volumes and a method of doing so will be described for medical applications. It will be appreciated that the system and method can also be applied to other applications as well, in general for inspection of the inner parts and structure of all objects which can be measured with a system, characterized by the fact that processing of the measurements results in a 3-dimensional dataset (3D array of measurements) representing a (part of the) volume of the object, and in which each data element or voxel relates to a particular position in the object and has a value which relates to one or more local properties of the object, for example for X-ray inspection of objects that can not be opened easily in the time available.

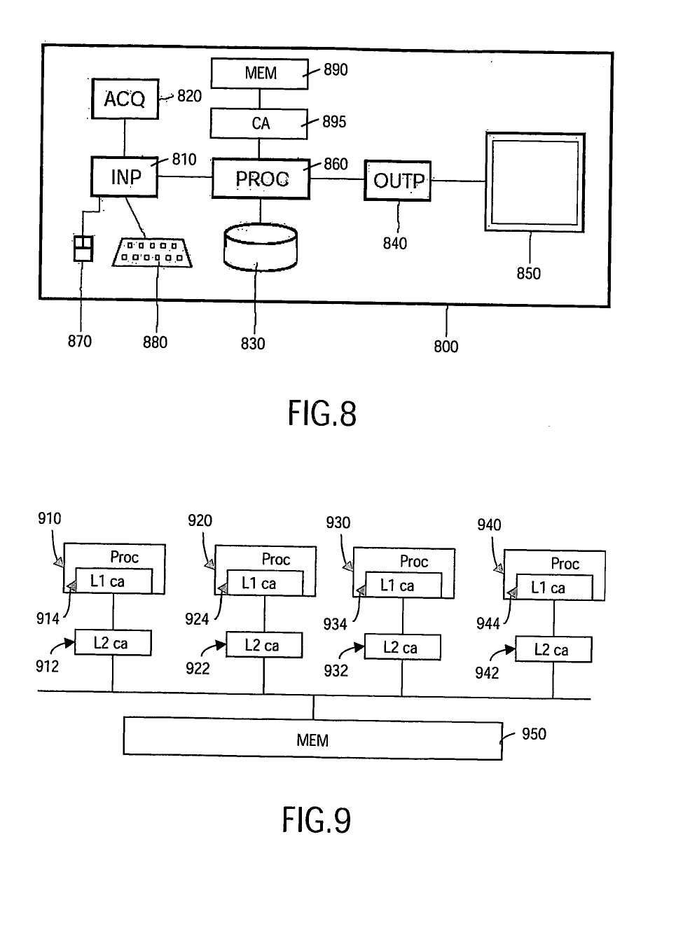

FIG. 8 shows a block diagram of the system according to the invention. The system may be implemented on a conventional computer system such as a workstation or high-performance personal computer. The system 800 includes an input 810 for receiving a three-dimensional set of data representing voxel values of the 3D volume. The data may be supplied via a conventional computer network, such as Ethernet, or telecommunications network, either wired or wireless, or combinations thereof, or via computer peripherals for reading common information carriers for magnetic or optical recording such as tapes, CD's, DVD's and the like, including solid state memories, such as flash memory. In FIG. 8, the image is acquired by an image acquisition device 820, such as a medical MR or CT scanner. Such acquisition device may be part of the system, but may also be external to the system. The system includes a storage 830 for storing the data set. Preferably, the storage is of a permanent type, such as a hard disc. An output 840 of the system is used for providing pixel values of a two-dimensional image for rendering. It may supply the image in any suitable form, for example as a bit-mapped image through a network to another computer system for display. Alternatively, the output may include a graphics card/chip set for direct rendering of the image on a suitable display 850. The display may, but need not be part of the system. The system may be able to provide simultaneously two 2D images for stereoscopic display. If so, two images are produced from two different viewpoints, each corresponding to a respective eye of a viewer. The system further includes a processor 860 for, under control of a computer program, processing the data set to obtain a 2-dimensional representation of the volume. The program may be loaded from a permanent storage, such as storage 830, into a working memory 890, such a RAM for execution. In the example, the same memory 890 may be used for storing the data from the storage 830 during execution. If the data set is too large to be fully stored in the main memory, the storage 830 may act as a virtual memory. The processor 860 is operative to projects the volume onto an imaginary 2D projection screen from a predetermined viewpoint by for each pixel of the 2D projection image:

Three important components of the computer system of FIG. 8 are processor, memory and cache memory. In modern computer systems, the memory latency is large (˜50 ns) with respect to the processor cycle time (<1 ns). Cache latency is usually only a few processor cycles (˜5 ns). The processor accesses memory through the cache memory to reduce the effects of memory access latency. FIG. 9 shows a preferred organization for high-performance rendering of 3D medical data. In this system, a Symmetric Multi-Processing (SMP) architecture is used with multiple processors (shown are 910, 920, 930 and 940) each with a respective cache (shown are 912, 922, 932, and 942), providing accelerated access to a single memory 950 containing the 3D data set. Preferably, a multi-cache hierarchy is used, with a first-level processor cache, that is typically embedded in the processor and provides very fast access to data in the cache, and a second level cache, that is faster then the memory, but slower then the first level cache. Such a multi-tier caching is known and will not be described further. In the example of FIG. 9, the caches 912, 922, 932, and 942 are the second level cache and the caches 914, 924, 934, and 944 are the respective first level caches. State of the art first level cache may be in the order of 64 Kbytes. Second level caches are in the order of 0.5 Mbyte to a few Mbytes. Cache sizes increase with advancements in processor and memory technology. It will be appreciated that the processing architecture according to the invention can also be used for a single processor system with only a single cache. The discrepancy between process cycle time and memory access latency is expected to grow as processor cycle times continue to decrease at a rate significantly higher than the decrease in memory access latency. Workstations used for medical image display have about 1 Gbyte of memory, processors with cycle times less than 1 ns and second level cache memories of about 2 Mbyte.

Common volume visualization techniques require in the order of 100 cycles per sample. For 50 ns memory and 1 ns cycle time the processor will be memory bandwidth limited when accessing memory more than twice per sample. For tri-linear interpolation, eight voxels must be accessed for each sample requiring eight memory accesses unless voxels are already available in the cache. Multi-slice CT volume data often consists of 1000 slices of 512² 16-bit voxels. This amounts to about 500 Mbytes of data. This amount of data clearly does not fit entirely in cache memory.

Cache memories provide accelerated access to a chunk of memory. Typically, caches are organized into cache lines, each typically storing 32 or 64 bytes of data Such a cache line would then hold 16 or 32 voxels, for a typical 2-byte voxel. When a single voxel is accessed, the entire cache line is retrieved from memory and stored in the cache regardless of whether or not the remaining voxels in the cache line are actually accessed. Accessing voxels in the order in which they are stored in memory results in only a single memory access every 16 or 32 voxels as successive voxels are retrieved from the cache line.

Associativity is a property of caches that defines that cache line that a specific memory location is mapped to. For a direct mapped cache, memory locations modulo the size of the cache map to the same cache line. Such memory locations are associated with the same cache line. For a 2-way set associative cache, memory locations modulo half the size of the cache map to the same cache line pair, each pair having its own association. For example, for a 2 Mbyte direct-mapped cache, memory locations separated by 2 Mbytes map to the same cache line. For 512² 16-bit slices each slice occupies 0.5 Mbytes of memory. For volumes allocated contiguously, voxels in every fourth slice would map to the same cache line. The cache associativity property results in samples taken at certain distances along the ray mapping to the same cache location. When rays are processed one at a time, this will result in non-optimal use of the cache, as cache contents will be replaced as the ray progresses through the volume.

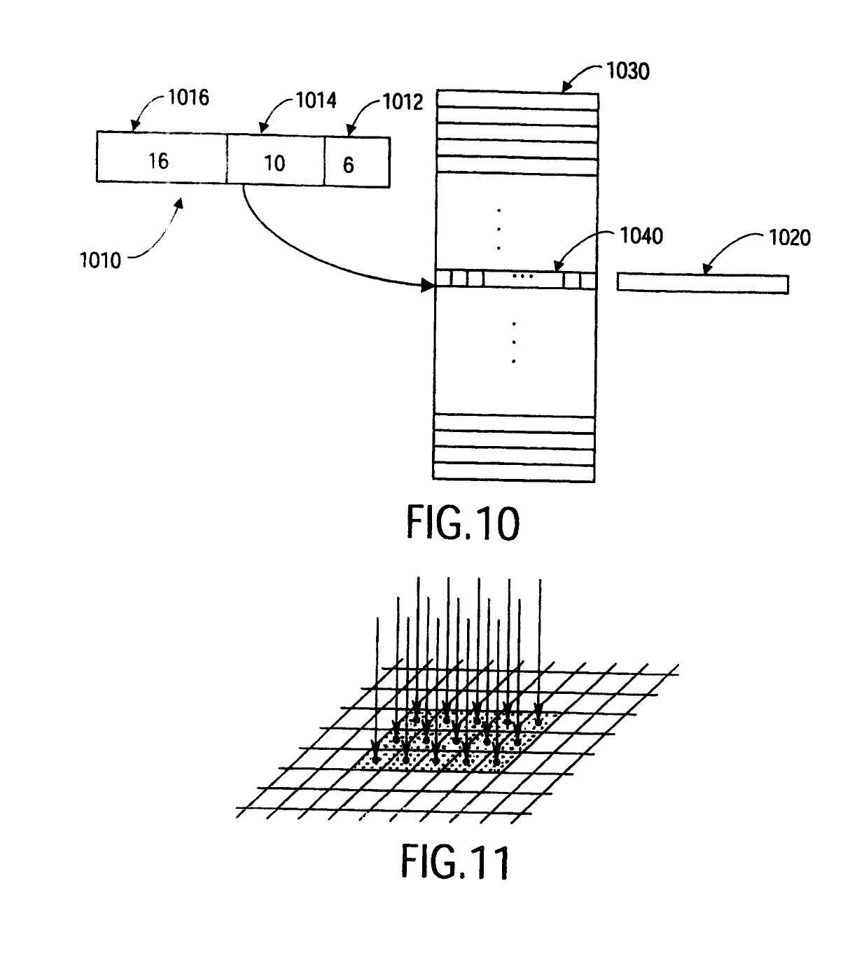

FIG. 10 shows an example of accessing a cache and mapping of memory locations to a cache line. In the example, 32-bit memory addresses are used. A cache line stores 64 (=2⁶) bytes. The cache 1030 consists of 1024 (=2¹⁰) cache lines, giving a total cache size of 64 Kbytes (typical for a first level cache). For each cache line, 16 bits are stored that indicate the 16 most significant address bits of the 32 bytes chunk currently being mapped into the cache line. In the figure, the 16-bit address is only shown once, using number 1020, for cache line 1040. For accessing the memory, the 32-bit address 1010 is divided in three parts. The six least significant bits 1012 indicate the byte within a cache line. The following 10 bits, shown as 1014, indicate the cache line. Each time a new memory address is provided, the cache line is determined, using the ten bits 1014. The 16 bits stored for that cache line in field 1020 are compared against the 16 most significant bits 1016 of the address. If this matches, the 64 byte data chunk that includes the requested data is already present in the cache line. The 6-least significant bits 1012 are then used to retrieve the desired data from the cache line. If no match occurs, the data is not yet in the cache. The relevant 64 byte chunk is then retrieved from the memory and stored in the corresponding cache line.

Bundle Blocks

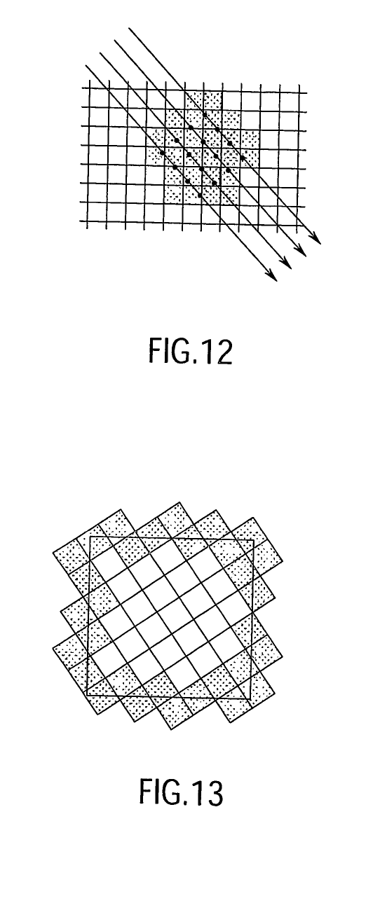

According to the invention, the processor is programmed to cast a parallel bundle of rays through the volume on a rectangle n₁×n₂ of pixels, as is illustrated in FIG. 11 for a bundle of 3 by 5 rays. A bundle is defined as a rectangular collection of projection rays. Each bundle generates a rectangular collection of pixels in the resulting projection image, the result of the volume visualization. In addition to treating a bundle of rays at a time, only a limited number of samples along each ray are taken. This results in a bundle block of samples. Along all the rays, n₃ sequential samples are determined. In itself, it is known how to determine samples along one ray. This mechanism is now used to determine n₃ samples along n₁×n₂ rays. It will be understood that n₁>1, n₂>1, and n₃>1. This mechanism results in a sequence of bundle blocks of each n₁×n₂×n₃ samples, and each time n₃ samples further along the bundle of rays. A predetermined interpolation algorithm is used to determine a 3D set of voxels contributing to the bundle block. Using a convention tri-linear interpolation function, this 3D set consists of the voxels within the block plus a shell of one more voxel deep around the block. This is illustrated in 2D in FIG. 12. The dots indicate the samples, and the gray areas indicate the voxels. The shaded voxels indicate voxels required for tri-linear interpolation of samples in 4 by 4 bundle block. Typical bundle blocks are 32 by 32 by 32 sample points. In this example, only 26 distinct voxels are accessed whereas 48 voxels are required for 16 tri-linear interpolations.

In general, for a given bundle block size of n₁×n₂×n₃, and respective zoom factors z₁, z₂, z₃, and a respective interpolation kernel size of k₁, k₂, k₃ a total of:
(n₁/z₁+k₁)*(n₂/z₂+k₂)*(n₃/z₃+k₃)
voxels are required for rendering a bundle block. In this formula, the zoom factor is the relation between the sample distance and the voxel distance (e.g. twice as many samples than there are voxels). The actual number of cache lines required depends on the orientation of the bundle block with respect to the voxel grid and the size of a cache line. Persons skilled in the art can easily select a suitable approach, for example choosing a bundle block that will fit into the cache irrespective of the orientation, or calculate a maximum size bundle block for a given orientation.

According to the invention, n₁, n₂, and n₃ are chosen such that the determined set of voxels fits into the cache. Using the formula given above, the person skilled in the art can easily choose such blocks. As a consequence of this choice, the determined set of voxels can be loaded in its entirety from the storage into the cache of the processor. This enables performing the sampling from cache. The sampling itself is known and is not described further here.

Preferably, the bundle block is a cube (n₁=n₂=n₃), making the working of the system direction independent.

The bundle block may be chosen such that the set of related voxels fits into a first level or second level cache. In a preferred embodiment, a larger bundle block whose related voxels all fit into the larger and slower second level cache. The large bundle block is then divided into smaller sub-bundle blocks whose related set of voxels fit into the faster (but smaller) first level cache. This sub-division follows exactly the same principle in which the entire set of voxels is divided into bundle block, where now a bundle block is divided into sub-bundle blocks. One way of describing the subdivision is to determine for each bundle block a sequence of sub-bundle blocks of each m₁×m₂×m₃, where 1<m₁<n₁, 1<m₂<n₂, and 1<m₃<n₃. Each sequential sub-bundle block being m₃ samples further in a direction along the ray. For each sub-bundle block, the predetermined interpolation is used to determine a 3D set of voxels contributing to the sub-bundle block. The determined set of voxels is then loaded from the level 2 cache into the level 1 cache. m₁, m₂, and m₃ are chosen such that the determined set of voxels fits into the level 1 cache. As has been described above, also a zoom factor may be taken into consideration. The sub-block level sampling is then performed from the level 1 cache.

It will be appreciated that in order to sample an entire volume, numerous bundle blocks (or sub-bundle blocks) must be sampled. Bundle blocks that cross the edges of the volume require clipping to avoid accessing outside the bounds of the volume. As clipping introduces additional overhead during sampling, clipping can be restricted to those blocks that actually cross the volume boundary. FIG. 13 shows the bundle blocks that require clipping of one or more voxels using shading. Clipping is known and will not be described further.

The loop control structure required to sample a volume by means of bundle blocks is as follows:

For all blocks in image row {

For all blocks in image column {

For all blocks in ray bundle {

For all samples in block row {

For all samples in block column {

For all samples in block ray {

Sample along ray

}

}

}

}

}

}

The outermost three loops iterate over all blocks in the volume and the innermost three loops iterate over all samples in a block. The innermost three loops directly resemble a straightforward sampling strategy.
Storing Slices with an Offset

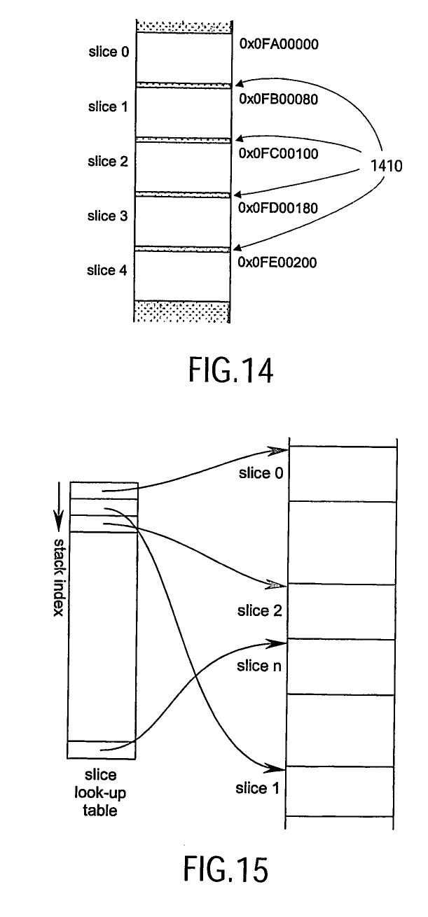

As described above, cache associativity can cause additional memory accesses when sampling in the column of stack direction of a volume. In order to avoid this behavior, voxel data can be organized to avoid the cache associativity that normally occurs without taking measures. The general principle to reducing cache associativity is to allocate successive slices of a volume such that voxels at a particular row and column position do not map to the same cache line for successive slices. This can be achieved with the introduction of an offset to the address of each slice. The offset is chosen to be a multiple of the cache line size (typically 32 or 64 bytes). Two cache lines are typically sufficient. The offset is introduced as a hole between slices. This principle is illustrated in FIG. 14. With number 1410 the holes are indicated in between the slices that are stored contiguously in the memory. In a typical example, there is a 512² 16-bit slice addressing with 128 byte holes. In this case, cache associativity occurs in the slice direction after 4096 slices.

In a preferred embodiment, a slice look-up table is used as is shown in FIG. 15. The slices of the volume are accessed through the slice loop-up table. The slice look-up table maps an index to a slice to the actual address at which the slice is located. Data of each slice is still stored contiguously in the memory, but successive slices need not be stored successively. Advantageously, holes can be created in between the slices, without the higher level application software needing to have knowledge of this. An additional benefit to memory organization in this fashion is that memory allocation and loading of volumetric data can be performed incrementally, one slice at a time.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and “include” and its conjugations do not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. A computer program product may be stored/distributed on a suitable medium, such as optical storage, but may also be distributed in other forms, such as being distributed via the Internet or wired or wireless telecommunication systems. In a system/device/apparatus claim enumerating several means, several of these means may be embodied by one and the same item of hardware. The mere fact that certain measures are recited in mutually different dependent claims does not indicate that a combination of these measures cannot be used to advantage.

1. A system for visualizing a three-dimensional (hereinafter “3D”) volume, in particular for medical applications; the system including:
an input (810) for receiving a data set representing voxel values of the 3D volume, organized in two-dimensional (hereinafter “2D”) slices with successive depths;
a memory (890) for storing the data set; each slice being stored in a contiguous block of the memory;
a memory cache (895) for temporarily storing part of the data set stored in the memory to provide faster access to data in the cache;
a processor (860) for, under control of a computer program, processing the data set to obtain a 2D representation of the volume by projecting the volume onto an imaginary 2D projection screen of pixels by:
casting a bundle of n₁×n₂ parallel rays through the 3D volume on a corresponding rectangle of n₁×n₂ pixels and each time sequentially determining n₃ sequential samples for each ray, giving a sequence of bundle blocks of each n₁×n₂×n₃ samples, where n₁>1, n₂>1, n₂>1, and n₃>1; and
for each bundle block: using a predetermined interpolation function to determine a 3D set of voxels contributing to the bundle block, n₁, n₂, and n₃ being chosen such that the determined set of voxels fits into the cache; loading the determined set of voxels from the memory into the cache; and performing the sampling from cache; and
an output (840) for providing pixel values of the 2D representation for rendering.

2. A system as claimed in claim 1, wherein the cache is a level 1 cache of the processor.

3. A system as claimed in claim 1, wherein the cache is a level 2 cache, and the system further includes a level 1 cache of the processor; the level 1 cache providing faster access to data than the level 2 cache; the level 2 cache being larger than the level 1 cache; the processor being operative to:
for each bundle block: determine a sequence of sub-bundle blocks within the bundle-block of each m₁×m₂×m₃ samples, each sequential sub-bundle block being m₃ samples further in a direction along the ray; where 1<m₁<n₁, 1<m₂<n₂, and 1<m₃<n₃; and
for each sub-bundle block:
use the predetermined interpolation function to determine a 3D set of voxels contributing to the sub-bundle block, m₁, m₂, and m₃ being chosen such that the determined set of voxels fits into the level 1 cache;
load the determined set of voxels from the level 2 cache into the level 1 cache; and
perform the sampling from the level 1 cache.

4. A system as claimed in claim 1, wherein n₁=n₂=n₃.

5. A system as claimed in claim 1, wherein the cache is organized in a plurality of cache lines, each with a same predetermined cache line size; the slices being stored sequentially in the memory with an offset between sequential slices in the memory of a multiple of the cache line size.

6. A system as claimed in claim 5, wherein the storage includes a slice look-up table for storing a memory address for each respective slice indicating a start address of the slice in the memory.

7. A method of visualizing a three-dimensional (hereinafter “3D”) volume, in particular for medical applications, wherein the 3D volume is represented by a data set of voxel values organized in two-dimensional (hereinafter “2D”) slices with successive depths; each slice being stored in a contiguous block of a memory (890) and being accessible through a memory cache (895) for temporarily storing part of the data set stored in the memory to provide faster access to data in the cache;
the method including processing the data set to obtain a 2D representation of the volume by projecting the volume onto an imaginary 2D projection screen by:
casting a bundle of n₁×n₂ parallel rays through the volume on a corresponding rectangle of n₁×n₂ pixels and each time sequentially determining n₃ sequential samples for each ray, giving a sequence of bundle blocks of each n₁×n₂×n₃ samples, where n₁>1, n₂>1, and n₃>1; and
for each bundle block: using a predetermined interpolation function to determine a 3D set of voxels contributing to the bundle block, n₁, n₂, and n₃ being chosen such that the determined set of voxels fits into the cache; loading the determined set of voxels from the memory into the cache; and performing the sampling from cache.

8. A computer program product for causing a processor to perform the steps of claim 7.
